(19) United States
(12) Patent Application Publication
(10) Pub. No.: US 2011/0107311 A1
(43) Pub. Date: May 5, 2011

(54) Communicating with Locally Networked Device from Remotely Hosted Browser Based Tool

(75) Inventors: Matthew S. McNulty, San Francisco, CA (US); Gregory R. Simon, San Francisco, CA (US)

(73) Assignee: HEWLETT-PACKARD DEVELOPMENT COMPANY, L.P., Fort Collins, CO (US)

(21) Appl. No.: 12/939,920

(22) Filed: Nov. 4, 2010

Related U.S. Application Data
(60) Provisional application No. 61/258,000, filed on Nov. 4, 2009.

(51) Int. Cl. G06F 9/44

(52) U.S. Cl. 717/129; 717/133

(57) ABSTRACT

Disclosed is a configuration for directly accessing a first computing system from a browser executing within a second computing system. One embodiment includes defining a browser code script for executing a predefined function call and defining a plurality of call functions executable by the browser code script. Each call function corresponds with a particular function on the first computing device. A direct communication link is established between a communication device driver on the second computing system and a communication device driver on the first computing system in response to the browser code script executing at least one call function of the plurality of call functions.

### CROSS REFERENCE TO RELATED APPLICATIONS

This application claims the benefit of U.S. Provisional Application No. 61/258,000, filed Nov. 4, 2009, which is incorporated by reference in its entirety.

### BACKGROUND

1. Field of Art

The disclosure generally relates to the field of development tools for mobile computing devices.

2. Description of the Related Art

Software development tools used to develop software application typically are hosted on a local computing device where the development is undertaken. However, such tools are complex and large in size so that installation and upgrades often consume large quantities of time and computing resources.

Web based software development tools provide an alternative to hosted development tools. Web based software development tools allow for development coding within the web browser. When the code is ready for execution for testing or transfer to other environments, the code is downloaded (“SAVE AS”) to the local device and then subsequently executed for testing or transferred to other environments. Although such configuration provide benefits of access to development tools without the costs of time and computing resources locally, such tools have other drawbacks. For example, web based tools are cumbersome with respect to seamlessness between development environment and testing and transfer environments.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. (FIG.) 1 illustrates one example embodiment of components of an example machine able to read instructions from a machine-readable medium and execute them in a processor (or controller).

FIG. 2 illustrates one example embodiment of a software development environment.

FIG. 3 illustrates one example embodiment of a sandbox bridge and code class configuration.

FIG. 4 illustrates one embodiment of an example application for searching an image collection.

FIG. 5 illustrates one example embodiment of a debugging tool for use in debugging the example application.

FIG. 6 illustrates one embodiment of example actions within the debugging tool.

FIG. 7 illustrates one example embodiment of execution of an operation within the example application.

FIG. 8 illustrates one example embodiment of the operation within the example application.

FIG. 9 illustrates one example embodiment of a command executed by the debugging tool for execution line-by-line of the example application until a breakpoint.

FIG. 10 illustrates one example embodiment of another command executed by the debugging tool to go past a breakpoint.

FIG. 11 illustrates one example embodiment of execution of the example application after the breakpoint.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium that includes a sandbox bridge (e.g., browser plug-in). In one embodiment, the configuration is implemented in a codescript, e.g., JAVA, but not limited to this approach. The JAVASCRIPT in a browser-based application allows for direct access to Java classes, avoiding the browser sandbox. The JAVA classes contain logic and code that knows how to interact with the device. Currently, the JAVA classes communicate with a mobile computing device via a TCP/IP wired connection, but are able to adapt to any connected device via any interface that uses the TCP/IP protocol. This could include over-the-air communication over cellular networks, BLUETOOTH networking, wireless networking (e.g., WiFi), or universal serial bus (USB) networking technologies over a USB cable (USBNet).

In one embodiment, a sandbox bridge comprises a plug-in interface that supports the following operations: packaging of application artifacts, installation of application package, removal of application package, launch of application on device, debugging of application on device. In one embodiment, it is configured through JAVA LIVECONNECT technology, which allows for direct calls from JAVASCRIPT to included JAVA methods/classes, which then interface with the device as if they were a locally installed application avoiding the browser sandbox.

The configuration as disclosed advantageously allows for use of browser based development tools to directly execute and analyze on a mobile computing device that is connected to the machine running the browser tool. Analysis may include determine failure points, executing other processes, debugging and the like. The sandbox bridge further increases efficiencies of the configuration by removing the step of downloading to a local computing device prior to conducting an analysis on the mobile computing device. This saves time, storage and processing resources.

### Computing Machine Architecture

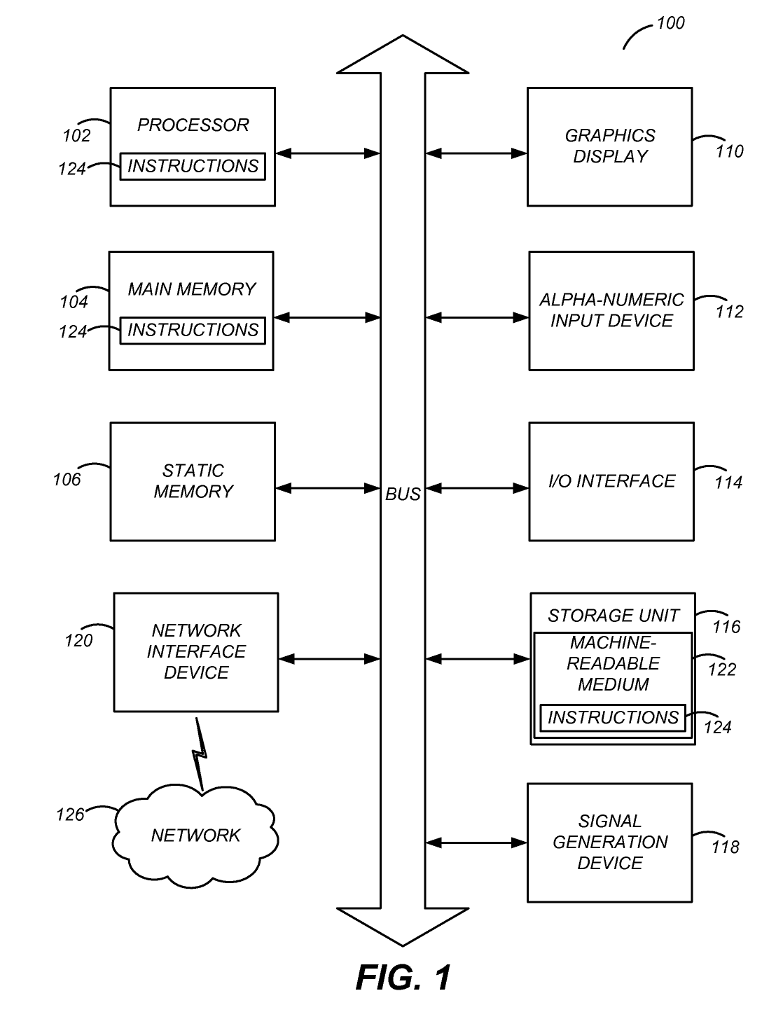

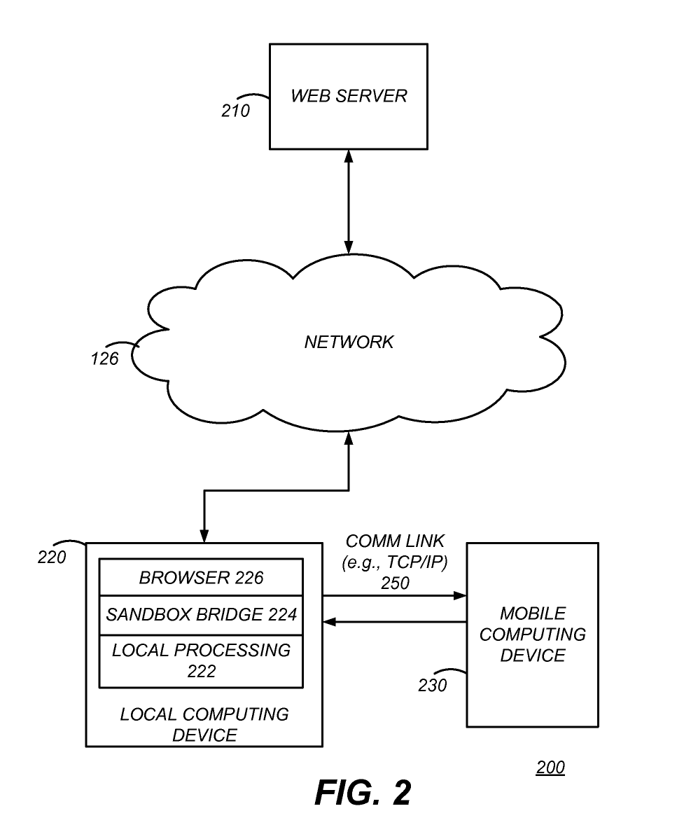

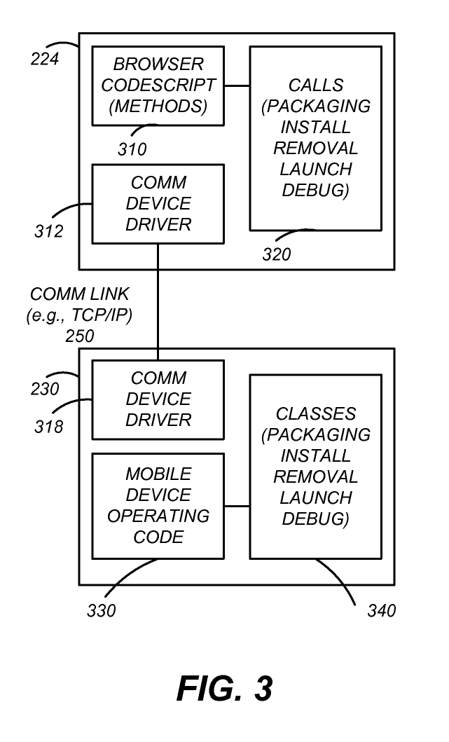

FIG. (Figure) 1 is a block diagram illustrating components of an example machine able to read instructions from a machine-readable medium and execute them in a processor (or controller). The configuration described herein is used with the processes and configurations described below, for example, with FIGS. 2 and 3. In those configurations further specific configurations of the machine are described, e.g., software configurations processed on a machine functionally structured as the example machine of FIG. 1.

Turning now to FIG. 1, illustrated is an example diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine 100 may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. The machine may further be configured to enable voice communication, e.g., through a data and/or voice communication channel. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include display unit 110 (e.g., to drive a plasma screen panel (PDP), a liquid crystal display (LCD), a projector, or a cathode ray tube (CRT)). The computer system 100 may also include alphanumeric input device 112 (e.g., a keyboard), an input/output (I/O) interface 114 (e.g., to communicatively couple a control device, a mouse, a trackball, a joystick, a motion sensor, or other instrument), a storage unit 116, a signal generation device 118 (e.g., a speaker), and a network interface device 120, which also are configured to communicate via the bus 108. Further, it is noted that configuration of the components may be combined in some embodiments, for example, the display unit 110 and I/O interface 114 may be combined in a touch capacitive, touch sensitive, the like screen configuration. In addition, the I/O interface 114 may include a communication module such as BLUETOOTH, WiFi (e.g., IEEE 802.11), Wi-Fi CERTIFIED Wi-Fi DIRECT, or WiMAX (e.g., IEEE 802.11) and may include a data bus such as universal serial bus (USB).

The storage unit 116 includes a machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 via the network interface device 120. It is noted that the network 126 includes a computing “cloud”. The computing cloud includes dynamically scalable and often virtualized resources as a service over the network 126 (e.g., the Internet).

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

### Software Development Environment

FIG. 2 illustrates one example embodiment of a software development environment 200. The software development network includes one or more web servers 210, one or more local computing devices 220 and a mobile computing device 230. For ease of discussion, only a single instance of each will be described herein, but such is not a limitation. Further, the web server 210, the local computing device 220, and the mobile computing device 230 include components functionally similar to the computer system (machine) 100. For example, the web server 210, the local computing device 220 and the mobile computing device 230 each include the display 110, the I/O interface 114, the network interface card 120, the processor 102, the main memory 124, and the storage unit 116. Further, each executes instructions 124. Further, the mobile communication device 230 may include a mobile communications subsystem (or components) to communicate with mobile communication system, for example, a cellular telephone communication system.

In one embodiment, the web server 210 and the local computing device 220 communicatively couple the network 126 through their respective network interface cards 120. The local computing device 220 communicatively couples the mobile computing device 230 using a TCP/IP communication protocol. The TCP/IP communication can occur through the I/O interface 114 of each device 220, 230. Hence, it is noted that in one embodiment, the TCP/IP communication can be through a wired connection, e.g., USB bus, or through wireless connection, e.g., WiFi DIRECT or BLUETOOTH.

The local computing device 220 includes local processing 222, a sandbox (or browser) bridge 224, and a browser (or browser application) 226. The local processing 222 refers to native processing directly on the local computing device 220. The browser 226 is an application launched (executed) on the local computing device 220. The browser interfaces with the web server 210 through the network 126. The web server 210 hosts a web site and corresponding web pages that can be accessed through a universal resource locator (URL) address. A developer interfaces with the accessed web pages through the browser and the work area within the browser may be referred to as a sandbox. The sandbox bridge 224 is configured to allow the browser area activity communicate directly with the mobile computing device 230 without a need to have to download to the local computing device 220. In one embodiment, the sandbox bridge 224 is configured to establish and communicate with the mobile computing device 230 via a communication protocol such as TCP/IP.

FIG. 3 illustrates one example embodiment of a sandbox bridge 224 and its interaction with the mobile computing device 230. As noted previously, the interaction is through a communication link 250 and corresponding protocol. For example, the communication link 250 can be BLUETOOTH or WiFi DIRECT or USB and the corresponding protocol operating over this link 250 can be TCP/IP. It is noted that in one embodiment, unlike conventional plug-in configurations, the sandbox bridge 224 is configured to use a network or other communications interface (e.g., USB) on the local computer to communicate with the mobile computing device. Accordingly, the browser 226 in the local computing device 220 can directly communicate with a communication interface (e.g., TCP/IP or Bluetooth interface) on the mobile computing device 230. In one embodiment, the sandbox bridge 224 can be a defined component that also includes an optional communications (comm) device driver 312 on the local computing device 220 that is configured to communicate with a like communication device driver 318 on the mobile computing device 230.

Continuing with the description of the sandbox bridge 224, the sandbox bridge 224 includes a browser code script 310 and a corresponding set of call functions 320. In one embodiment, the code script 310 comprises JAVASCRIPT and the call functions 320 comprises JAVA function calls, for example, packaging, install, removal, launch, and debug. The mobile computing device 230 may operate using a browser based operating system code 330, e.g., PALM WEBOS. The mobile computing device 230 includes one or more functional code classes 340. The functional code classes correspond to the call functions 320, which in this example are packaging, install, removal, launch, and debug. Alternately, call functions may include application code packaging, installation of an application on a device/emulator, removal of an application on device/emulator, launch application, and the like.

In one embodiment, within the browser 226, a developer may execute seek to execute a particular function on the mobile computing device 230, e.g., launch a particular application. The developer identifies the application and executes a code script 310 assigning a particular call function 320, e.g., launch. The sandbox bridge 224 transmits the code script 310 and call function for launch 320 via TCP/IP over the communication link 250 to the mobile computing device 230. The mobile computing device 230 receives the call function 320 and locates the corresponding code class 340, e.g., here, for launch. Once located the code class 340 used to launch, or executes, the particular application.

By way of example in one embodiment, a sandbox bridge 224 configured as a plug-in interface supports the following operations: packaging of application artifacts, installation of application package, removal of application package, launch of application on device, debugging of application on device. The communications between the devices can be illustrated through the following JAVASCRIPT beginning with creating a gateway to the webOS application programming interface (API):

----- Webosconnect.js -----
/*** Webosconnect provides a gateway to the webOS API. The
configuration uses LiveConnect which provides JavaScript with
the ability to call methods of Java classes. */
opus.Class(“Palm.Webos.Webosconnect”, {
isa: opus.Control,

renderApplet: function( ) {
// create an applet element

this.applet = document.createElement(“applet”);

this.applet.setAttribute(“name”, “webosconnect”);
this.applet.setAttribute(“archive”, opus.path.rewrite(“$Palm-

Webos/assets/webOSconnect.jar”));

// set the Java class that can be accessed in JavaScript
this.applet.setAttribute(“code”,

“com.palm.webos.connect.DeviceConnection”);

// To enable JSObject support in Java plug-in, set myscript to
true
this.applet.setAttribute(“myscript”, “true”);
this.applet.style.visibility = “hidden”;
this.node.appendChild(this.applet);

}

});

The process continues with the example code, which causes an application, identified by “appName” to be launched on the mobile computing device 230, which is identified in the code by “deviceID”.

----- ide.js -----
launch: function( ) {

// get a handle to the Webosconnect object
var wc = this.owner.getWebosconnect( );
// call launchApp which is a method in the DeviceConnection Java
class
wc.launchApp(deviceId, appName);

}
Java: (plugin environment, acting locally on client machine)

Next, the process creates a connection to the mobile computing device 230. Specifically, the JAVASCRIPT code provides:

----- DeviceConnection.java -----
/**
* Launch application on the device.
*
* @param deviceId UID of the device
* @param appName name of the application to remove
* @return true on success, false on failure
*/
public boolean launchApp(final String deviceId, final String appName) {

try {

doPrivileged(new PrivilegedExceptionAction<Void>( ) {

public Void run( ) throws Exception {

(new

Launcher( )).launchApp(NovacomUtil.connect(findNovacomDevice(deviceId)),
appName, null);

return null;

}

});
return true;

} catch (PrivilegedActionException ex) {

return false;

}

}

With the above configuration, the sandbox bridge 224 on the local computing device 220 is configured to establish and directly communicate with the mobile computing device 230. In this example, the code illustrates a particular command for launching an application on the mobile computing device 230. Other commands, for example, debugging command, would have similar code construction. The structure of the code can be used for the sandbox bridge 224 as well as a JavaScript in the browser.

### EXAMPLE OPERATION USING DEBUGGING TOOL

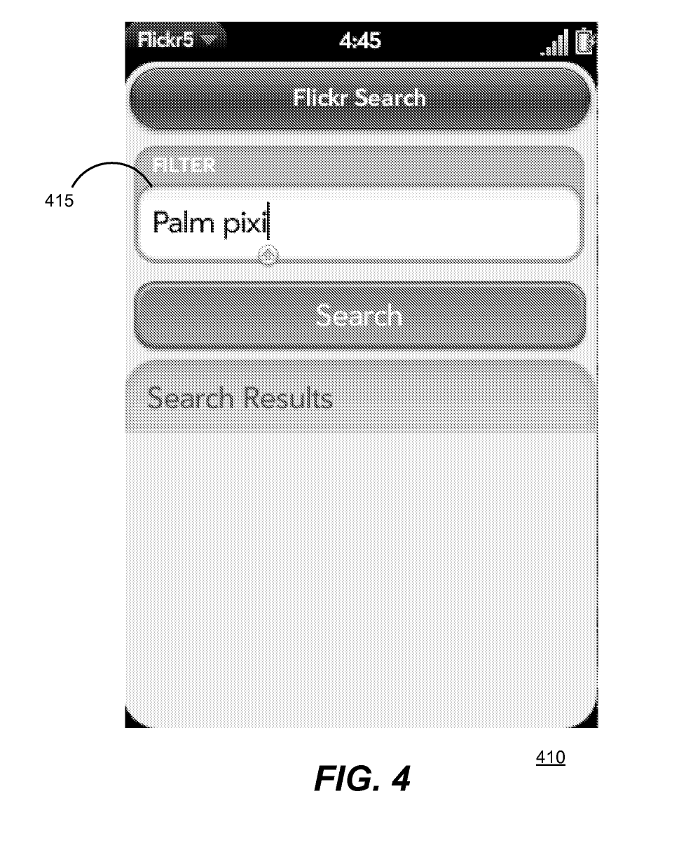

FIGS. 4-11 illustrate one example embodiment of operation of the disclosed configuration in which a debugging tool, which is part of development environment that is hosted on the web server 210, is accessed by the user through a browser on the local computing device 220. The example embodiment is articulated through user interface illustrations in which the user interfaces are rendered through a machine, such as the machine 100 and/or the mobile computing device 230.

The mobile computing device 230 communicatively couples the local computing device through the communication link 250. In this example operational description, FIG. 4 illustrates a user interface 410 rendered in one embodiment of an example application for searching an image collection. In this context, the application is a FLICKR application executing as it would on the mobile computing device 230 and is communicatively coupled with the local computing device 220, e.g, via a wired or wireless connection. The application searches the FLICKR image collection using the free FLICKR web application programming interface (API). In this example, application receives the input “Palm pixi” in a data entry box 415 that in this example is for filtering a search with these terms. Next, an example debugging aspect will be described in this context.

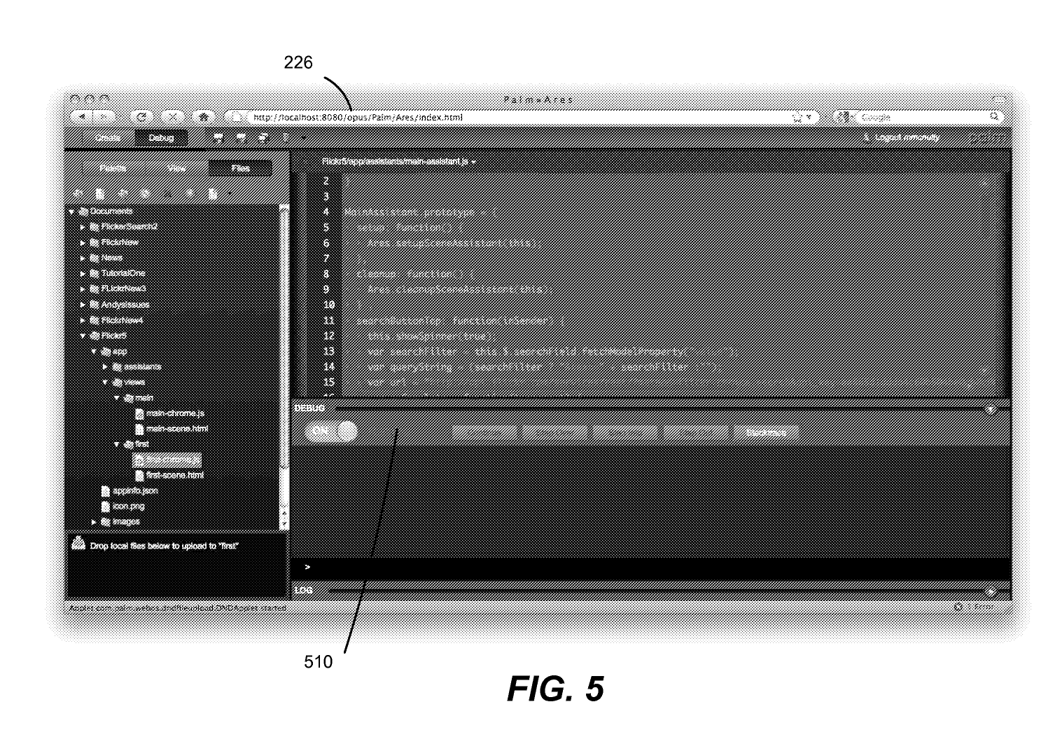

FIG. 5 illustrates an example embodiment of a user interface for a debugging tool, e.g., ARES, that will be used for debugging the example application, e.g., FLICKR in this example. In this example, a developer suspects that the search string being typed into the “Filter” field is not being passed to the FLICKR API correctly, so the developer wants to determine whether the code is properly working The test will be run using the search term “Palm pixi.” The developer uses an online version of the debugging tool, e.g., ARES, which hosted at the web server 210. This site is accessed via the browser 226 on the local computing device 220. The developer opens a project, opens the debugger mode, and turns on the debugger, which starts running 510.

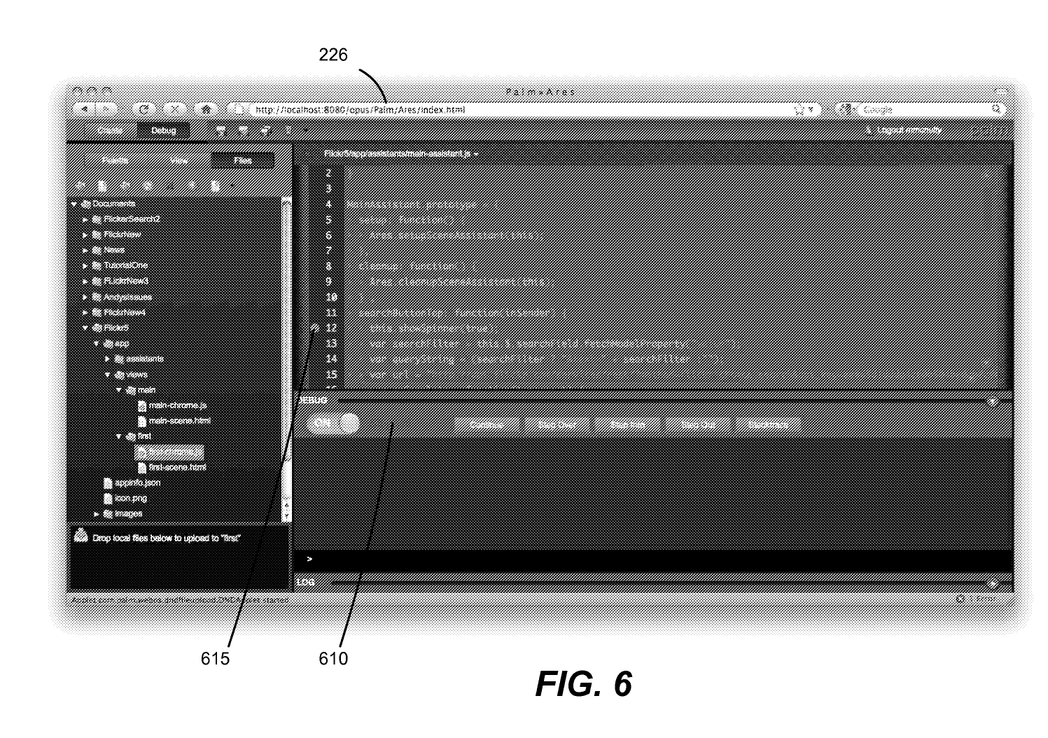

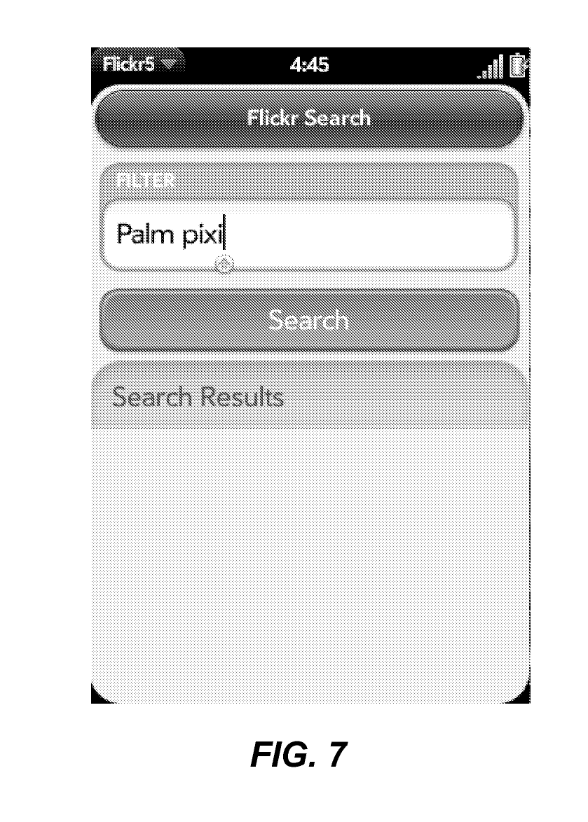

FIG. 6 illustrates one embodiment of example actions within the debugging tool. In particular, the developer sets a “breakpoint”, which issues a “set breakpoint” command via the sandbox bridge 224 and the communication link 250 to the mobile computing device 230 on which the application is running In this example, the breakpoint 615 is set (dot in figure) at line 12. The command includes the name of the file and the line number to “break” on. The developer opens the application on the mobile computing device 230. The code is set to break (or stop 610) right before the line suspected of the problem (e.g., line 14 in FIG. 6). FIG. 7 illustrates one embodiment of execution of an operation within the example application and where the code is configured to stop 610 at line 12 in FIG. 6. This example illustrated is the same as illustrated in FIG. 4.

It is noted that although this aspect is described in the context of the mobile computing device 230, alternate embodiments of this particular debugging tool can be configured to work with an emulator application that emulates the mobile computing device on the local computing device 220 or another computing machine. The emulator may be on the local computing device or may be remote to it. It is noted that the emulator could itself be hosted on the internet or on a remote server.

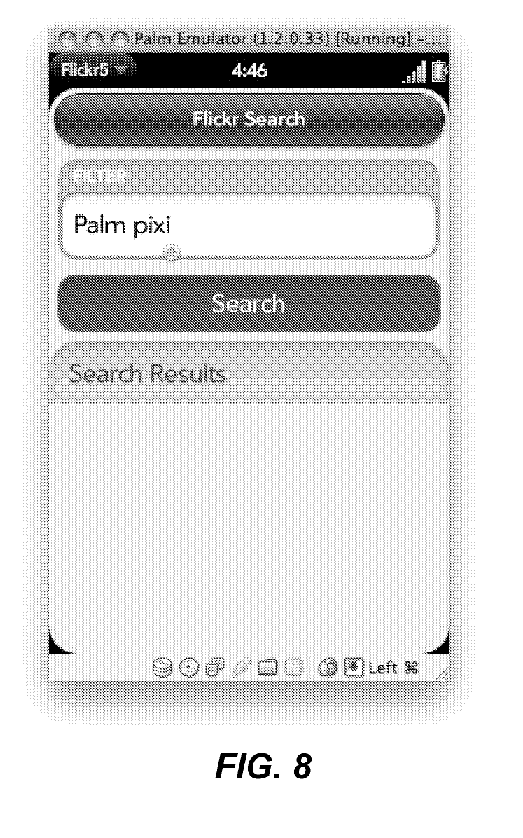

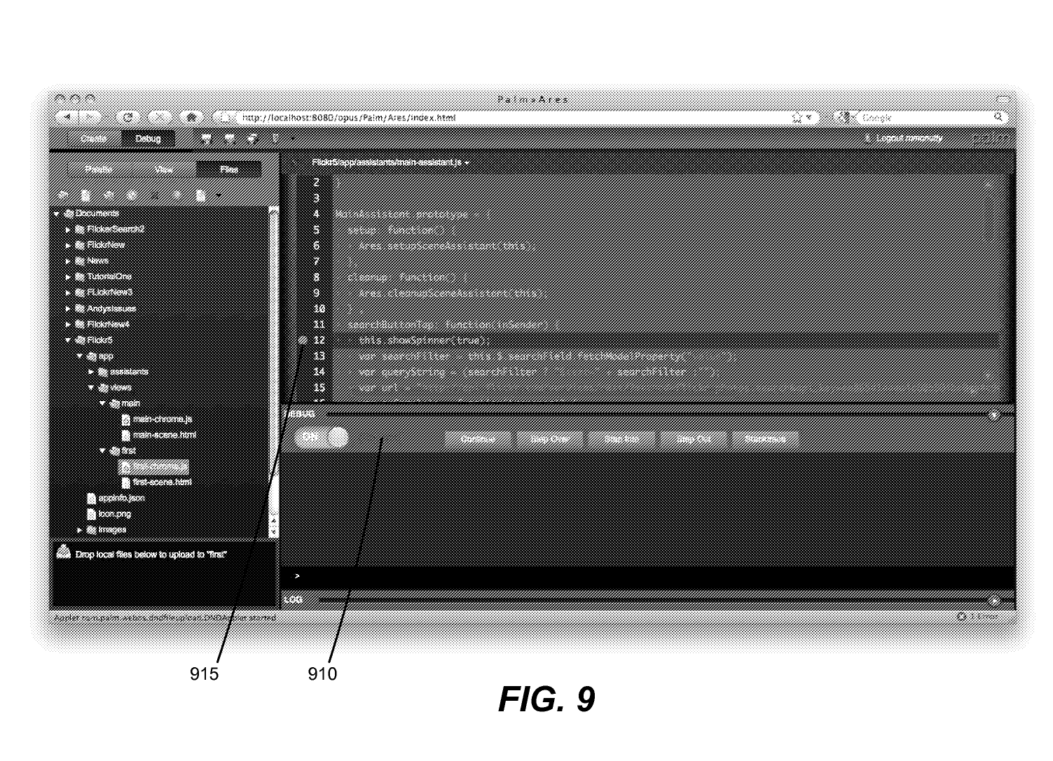

Next, FIG. 8 illustrates one embodiment of the operation within the example application. Specifically, the application is run on the mobile computing device 230. The application is configured so that the command to execute is sent from the browser 226, the sandbox bridge 224, over the communication link 250 and onto the mobile computing device 230. Here, the developer clicks on the “Search” button, which calls the code in question. As the application is executing, the application freezes at the correct spot, and the debugger highlights the line it has stopped 910 on. The application is executed line by line until the desired line suspected of a problem is reached, specifically, line 12 (915) in FIG. 9.

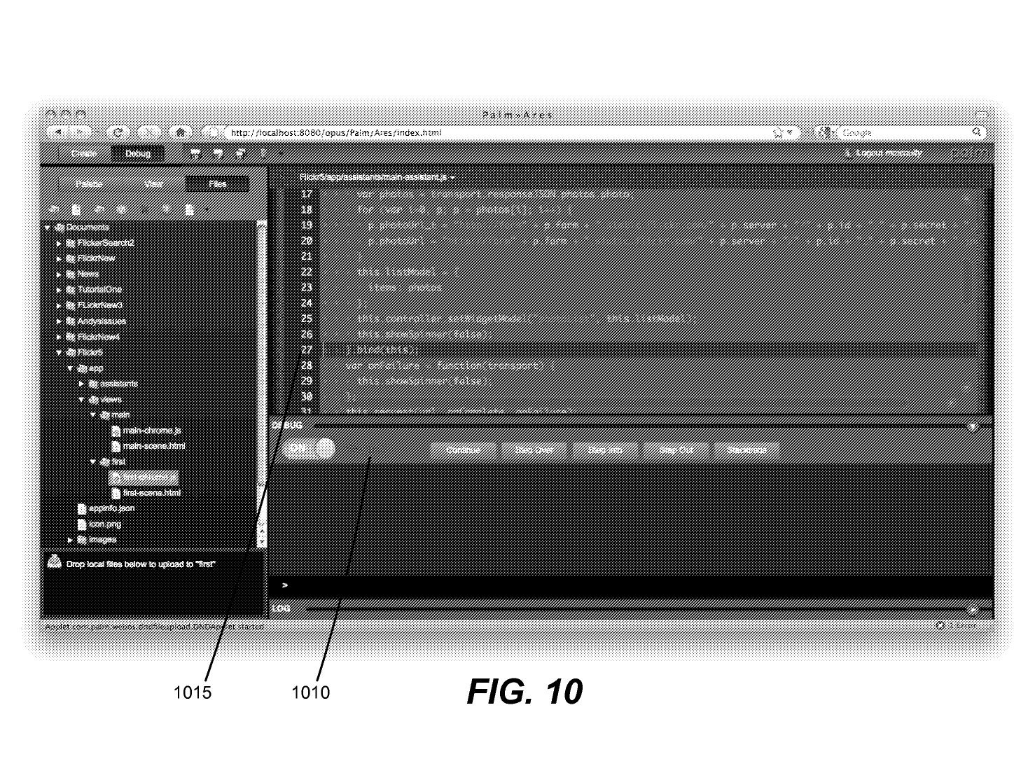

FIG. 10 illustrates one embodiment of another command executed by the debugging tool to go past a breakpoint. Here, the developer now issues a “step over” command, to the mobile computing device (again, through the sandbox bridge 224 and communication link 250). The set-over command steps line by line, executing the code line by line, until the developer reaches a point past the offending line (e.g., here, to line 27 (1015) in the code). The developer uses the console (the blank space with the > prompt at the bottom) to “inspect” the value of the variable declared on line 14. The developer determines the variable value is incorrect, and now knows where the problem is, issues a “continue” command, which causes the application to continue running normally. The developer then issues an “unset breakpoint” command to the device, so that the next time the app runs normally again.

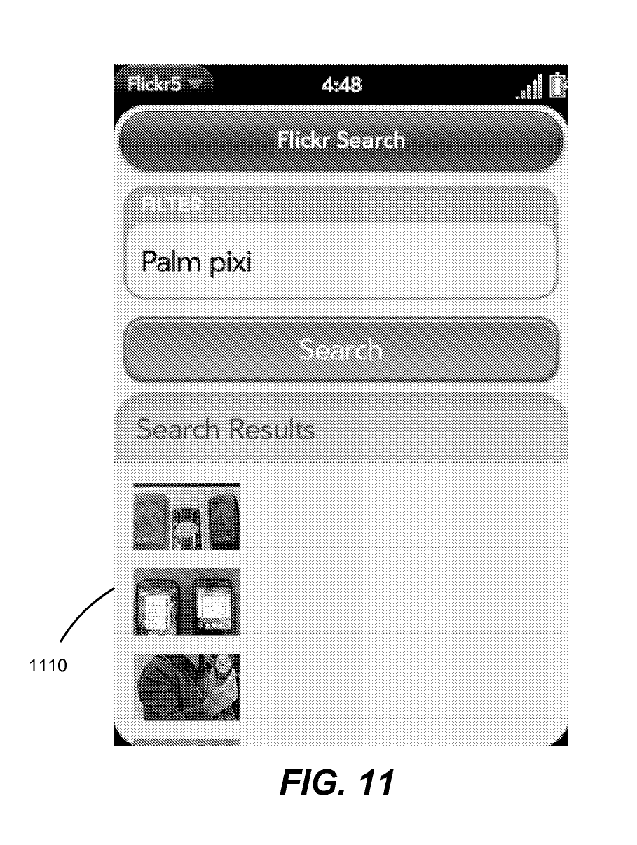

FIG. 11 illustrates one embodiment of execution of the example application after the breakpoint. In this example, with the issuing of the “continue” command, the application finishes the code being called. The result is a display 1110 of the search results in the application on the screen of the mobile computing device 230.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems or machines (e.g., a standalone, client or server computer system) or one or more hardware modules of a computer system (e.g., a processor or a group of processors) may be configured by software (e.g., an application or application portion) as a hardware module that operates to perform certain operations as described herein. An example of such configurations was illustrated in FIG. 1.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein, for example, through FIGS. 4-11, may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital values within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for communicating with a locally attached device from a remotely hosted browser tool through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for directly accessing a first computing system from a browser executing within a second computing system, the method comprising:
defining a browser code script for executing a predefined function call;
defining a plurality of call functions executable by the browser code script, each call function corresponding to a particular function on the first computing device; and
establishing a direct communication link between a communication device driver on the second computing system and a communication device driver on the first computing system through the web browser on the first computing device in response to the browser code script executing at least one call function of the plurality of call functions, the at least one call function for executing a corresponding function on the first computing device.

2. The method of claim 1, wherein the second computing device comprises a mobile computing device having mobile system communication components.

3. The method of claim 1, wherein the plurality of call functions includes at least one of package, install, remove, launch and debug.

4. The method of claim 3, wherein the first computing device includes a plurality of code classes corresponding to the plurality of call functions.

5. The method of claim 1, further comprising defining, in a debugging application executing in the browser on the second computing system, a breakpoint of an application executable in the first computing system.

6. The method of claim 5, further comprising stopping the debugging application at the break point in response to the application executing on the first computing device and reaching the breakpoint in execution.

7. A non-transitory computer readable storage medium storing instructions thereon, the instructions when executed cause at least one processor to:
define a browser codescript for executing a predefined function call;
define a plurality of call functions executable by the browser codescript, each call function corresponding to a particular function on the first computing device; and
establish a direct communication link between a communication device driver on the second computing system and a communication device driver on the first computing system in response to the browser codescript executing at least one call function of the plurality of call functions, the at least one call function for executing a corresponding function on the first computing device.

8. The computer readable storage medium of claim 7, wherein the second computing device comprises a mobile computing device having mobile system communication components.

9. The computer readable storage medium of claim 7, wherein the plurality of call functions includes at least one of package, install, remove, launch and debug.

10. The computer readable storage medium of claim 9, wherein the first computing device includes a plurality of code classes corresponding to the plurality of call functions.

11. The computer readable storage medium of claim 7, further comprising instructions that cause the at least one processor to define, in a debugging application executing in the browser on the second computing system, a breakpoint of an application executable in the first computing system.

12. The computer readable storage medium of claim 11, further comprising instructions that cause the at least one processor to stop the debugging application at the break point in response to the application executing on the first computing device and reaching the breakpoint in execution.
